(19) United States
(12) Patent Application Publication
(10) Pub. No.: US 2018/0360240 A1
(43) Pub. Date: Dec. 20, 2018

(54) MOSQUITO REPELLENT AND ANTIBACTERIAL PICNIC MAT

(71) Applicant: Modus Light, LLC, Overland Park, KS (US)

(72) Inventor: Yu Yun Chiang, Taipei City (TW)

(21) Appl. No.: 15/829,258

(22) Filed: Dec. 1, 2017

(30) Foreign Application Priority Data
Jun. 16, 2017 (TW) 106208772

(51) Int. Cl. A47G 9/06; A01M 29/12; A47G 9/00

(52) U.S. Cl. CPC A47G 9/062; A47G 9/007; A01M 29/12

(57) ABSTRACT

A mosquito repellent and antibacterial mat includes a mat body. The upper surface cloth includes a surface cloth layer formed by a surface cloth including a mosquito repellent agent and antibacterial agent, and a coating layer. A plurality of parallel filler spaces arranged at intervals are arranged and spaced between the upper surface cloth and the lower surface cloth. The mosquito repellent and antibacterial picnic mat further includes a plurality of airholes, which are disposed on at least one side of the mat body and for selectively allowing flow or air between the plurality of filler spaces an exterior of the mat body. A sealing cap allows a user to selectively block flow of air through the airholes. Thus, the mosquito repellent and antibacterial picnic mat of the present invention achieves mosquito repellent and antibacterial effects as well as being comfortable and compressible in size to be readily portable and stored.

### BACKGROUND OF THE INVENTION

### Field of the Invention

The present invention relates to an antibacterial and a mosquito and insect repellent picnic mat for outdoor use.

### Description of the Related Art

With the rising demand of outdoor recreational activities in the recent years, picnics and outings have become increasingly popular. Resting and enjoying food on the ground in the suburbs and being immersed in nature is one of the great pleasures during leisure time of people today. However, sitting directly on lawns, dirt or sand may be uncomfortable and inconvenient because of the humidity or filthiness of such places. Therefore, picnic mats are essential.

A conventional picnic mat is usually made of canvas, tinfoil, or a common fabric materials, for placing drinks or food thereon as well as allowing people to sit thereon. Conventional picnic mats are not designed to be antibacterial or repel mosquitos, while providing comfort.

An outdoor environment that has high humidity is especially susceptible to being infested with mosquitoes, insects and bacteria, and all types of activities conducted under such conditions are prone to invasions of all sorts of bacteria, mosquitoes and insects, causing infections or physical discomforts and hence lowered body functions that may lead to various undesirable consequences. Carrying large amounts of mosquito repellent or sterilization supplies and devices is often not possible and inconvenient for outdoor picnic and outing activities. In summary, with respect to designs of conventional picnic mats, in addition to lacking softness and comfort, very few of those designs can achieve antibacterial as well as mosquito and insect repellent effects.

The structure of an improved picnic mat needs to satisfy criteria of being soft, comfortable and readily portable, and also need to withstand damp ground and a humid outdoor environment susceptible to the growing of mosquitoes, insects and bacteria, and provide antibacterial as well as mosquito repellent effects without relying on complicated mosquito repellent or sterilization supplies. However, commercially available picnic mats aiming for convenience and portability are mostly uncomfortable or easily worn and torn due to being too thin and light, leading to utilization damage and hardly providing leisure quality; for those aiming for mosquito repellent and antibacterial effects, a large amount of supplies or accessories usually need to be additionally purchased.

Therefore, there is a need for related industrialists to provide an ideal, practical and innovative solution to solve the problems of conventional picnic mats to meet requirements of consumers.

### SUMMARY OF THE INVENTION

In view of the above problems, the present invention provides a simple, convenient and advanced design for solving the above noted problems. The solution of the present invention achieves greater benefits and at the same time provides application flexibilities and is economical.

The problems to be solved by the present invention, while not required to be solved by all embodiments of the invention, are: 1) a conventional picnic mat has a much too simple structure and fails in simultaneously satisfying purposes of being soft, comfortable and readily portable; and 2) a conventional picnic mat needs to be used with additional mosquito repellent and antibacterial products in order to achieve repellent and antibacterial effects.

To solve the foregoing problems, various embodiments of the present invention are targeted at achieving effects of: 1) effectively improving the softness, comfort and readily portability of a picnic mat through a combined provision of compressible fillers containing gaps; and 2) achieving effective waterproofing by applying an adhesive coating layer on a cloth surface of the picnic mat and further providing mosquito repellent and antibacterial results using a fabric combined with effective mosquito repellent and antibacterial agents, thus providing an effective way of repelling mosquito and producing antibacterial effects.

To further describe and solve the problems of the prior art and to achieve the expected effects, the present invention provides a mosquito repellent and antibacterial picnic mat comprising: a mat body, including an upper surface cloth and a lower surface cloth, the upper cloth including a surface cloth layer and an adhesive coating layer, the surface cloth layer formed by a surface cloth having a mosquito repellent agent substantially covering the cloth and an antibacterial agent, the adhesive coating layer provided on a surface of the surface cloth layer; a plurality of parallel filler spaces arranged and spaced between the upper surface cloth and the lower surface cloth of the mat body; and a plurality of airhole portions, disposed on at least one side of the upper surface cloth of the mat body, for allowing the plurality of filler spaces to be in air flow communication with an exterior of the mat body respectively.

In one embodiment, the mosquito repellent and antibacterial picnic mat of the present invention further includes a plurality of compressible fillers with gaps. The plurality of fillers respectively fills the plurality of filler spaces.

In another embodiment, the mosquito repellent and antibacterial picnic mat of the present invention further includes at least one cladding layer. One side of the at least one cladding layer is connected to one side of the mat body having the airhole portions so as to cover the airhole portions.

In another embodiment, the mosquito repellent and antibacterial picnic mat of the present invention further includes a sealing portion. The sealing portion covers the airhole portions to accordingly separate the filler spaces from the exterior of the mat body.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram and perspective view of a mat body according to an embodiment of the present invention;

FIG. 2 is a side view of a mat body according to an embodiment of the present invention;

FIG. 3 is an enlarged partial cross sectional view, taken within circle b of FIG. 2, of the mat body with an upper surface cloth, a lower surface cloth and filler spaces according to an embodiment of the present invention;

FIG. 4 is a perspective view of an embodiment of a mat according to the invention illustrating a mosquito repellent and antibacterial picnic mat including a cladding layer;

FIG. 5 is a perspective view an embodiment of a mat according to the invention illustrating a mosquito repellent and antibacterial picnic mat including a sealing portion;

FIG. 6 is an enlarged cross sectional view of the sealing portion shown in circle c in FIG. 5 according to an embodiment of the present invention; and

FIG. 7 is a folded perspective view of the mosquito repellent and antibacterial picnic mat of FIG. 5, according to an embodiment of the present invention.

### DETAILED DESCRIPTION OF THE INVENTION

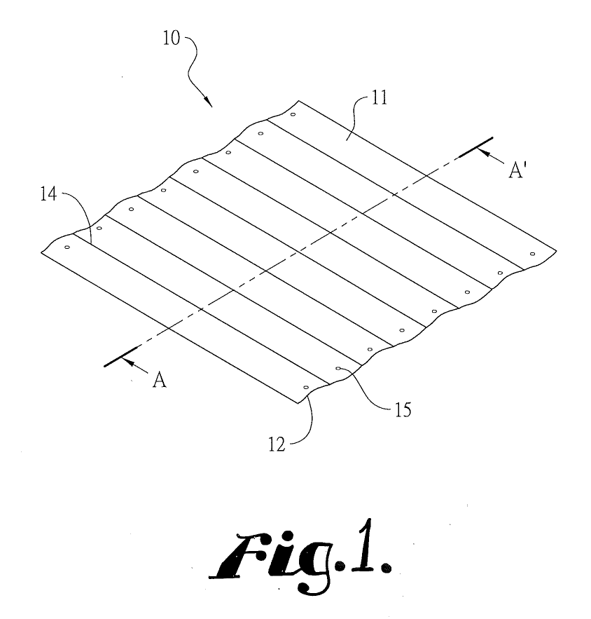

FIG. 1 shows a mat body 10 according to an embodiment of the present invention. A mosquito repellent and antibacterial picnic mat of the present invention includes the mat body 10, which includes an upper surface cloth layer 11 and a lower surface cloth 12. The upper surface cloth 11 includes a surface layer 21 and an adhesive coating layer 22. The surface cloth layer 11 is formed by a cloth preferably entirely provided with a mosquito repellent agent and an antibacterial agent incorporated into the cloth 11. The adhesive coating layer 22 covers a surface of the surface cloth layer 21. A plurality of parallel filler spaces 23 arranged and spaced between the upper surface cloth 11 and the lower surface cloth 12 of the mat body 10. A plurality of airhole portions including airholes 15 are disposed on at least one side of the upper surface cloth 11 of the mat body 10 and provide for a plurality of filler spaces 23 to be in communication with an exterior of the mat body 10 and the ambient atmosphere thereabout.

The surface cloth layer 21 is provided with a mosquito repellent treatment with an added mosquito repellent agent during a padding process performed by a fabric forming machine. The amount of mosquito repellent agent added is 4% to 6% to the fabric weight, and drying is performed under a temperature of 130° C. to 150° C. After the padding process performed by the fabric forming machine, the surface cloth layer 21 is further provided the a waterproofing treatment with an added waterproofing agent. The amount of the waterproofing agent added is 4% to 6% to the fabric weight and drying is performed under a temperature of 140° C. to 180° C.

The above mosquito repellent agent is preferably an all-natural plant antiparasitic auxiliary agent, PROFYL NK10 which is a mosquito and insect repellent auxiliary agent and geraniol is a main active substance of a finishing agent of the NK10. These substances are essences extracted from plant, so as to offer various benefits, be effectively biodegradable, and provide perfect balance from environment, performance and safety perspectives. NK10 has an environmental effective degradation rate of 95%, and is verified by Oeko-Tex, making NK10 a safe and environmental friendly chemical mosquito and insect repellent auxiliary agent. It is foreseen that other insect repellents may be used for the purpose.

After completing the two processes of applying the mosquito repellent treatment and the waterproofing treatment, a coating process is performed on the mosquito repellent treated and waterproof treated surface cloth layer 21. For the formula of the adhesive coating layer, the coating glue used for the adhesive coating layer is preferably common solvent-based polyurethane coating glue, which has a good bonding performance and can easily form a cross-linking reaction with a fabric. Further, a solvent-based polyurethane coating glue is more durable than water-based polyurethane, with the amount applied preferably being 10 g/m² to 40 g/m².

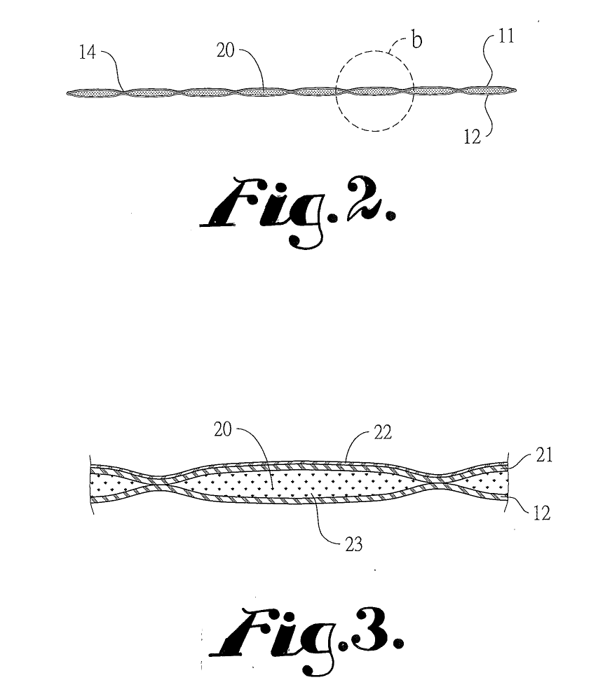

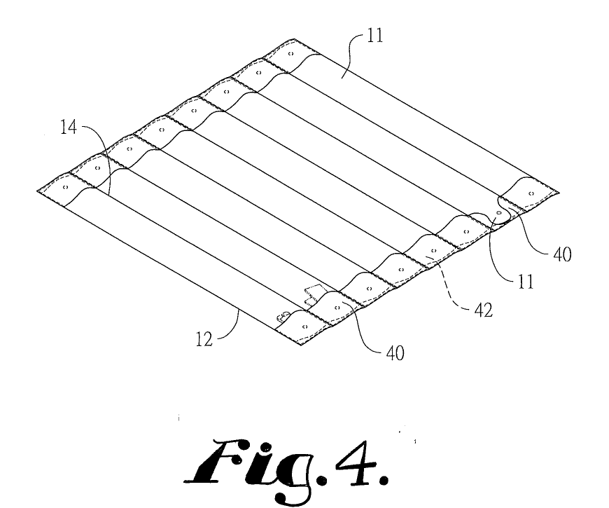

FIG. 2 is a side view of the mat body 10 according to an embodiment of the present invention. FIG. 3 shows an enlarged cross section of the mat body 10 with the upper surface cloth 11, the lower surface cloth 12 and the filler spaces 23, shown in the cross section indicated by the circle b of FIG. 2. The adhesive coating layer 22 includes coating glue, which preferably includes a polyurethane coating glue, N, N-dimethylformamide, a bridging agent and an antibacterial agent. The mosquito repellent and antibacterial picnic mat further includes a plurality of filling material or compressible fillers 20 having air gaps therebetween. These fillers 20 respectively fill the plurality of filler spaces 13. In one embodiment, the fillers 20 are at least one of cotton, foam sponge and feather.

The foregoing antibacterial agent is preferably an antibacterial agent from an Ultra-Fresh™ product series of a Canadian organization, Thomson Research Associates. The model of the antibacterial agent adopted in the present invention is Ultra-Fresh DM25, which is an antimicrobial, antifungal and antimite antibacterial agent that is registered in and verified by the U.S. Environmental Protection Association (EPA). Ultra-Fresh DM25 is an antibacterial agent in a solvent-based carrier. In one preferred embodiment, the antibacterial agent is suitable for products such as a solvent-based polyurethane coating, polyvinyl chloride and foam sponges.

The bridging agent is preferably also a polyurethane type bridging agent and has better compatibility with the polyurethane coating glue and a stronger bonding force, providing a fabric to which it is applied with higher resistance against water pressure and excellent application durability. The N, N-dimethylformamide is for diluting the polyurethane glue to have an appropriate viscosity. During the coating process, a fixed amount of the solvent-based polyurethane glue, a fixed amount of the antifungal and antibacterial agent DM-25, a fixed amount of the polyurethane bridging agent, and a fixed amount of the N, N-dimethylformamide are prepared and mixed with a polyurethane glue to be applied as an adhesive coating layer. The prepared glue is then applied onto the cloth surface by knife coating (a coating device) and the cloth is placed in an oven to dry and completely evaporate the N, N-dimethylformamide from the glue. In one preferred embodiment, the number of the adhesive coating layers is two to three.

FIG. 4 shows an embodiment of a mosquito repellent and antibacterial picnic mat according to the present invention. The mosquito repellent and antibacterial picnic mat further includes at least one cladding layer 40. One side of the cladding layer 40 is connected or joined to one side of the mat body 10 having the airholes 15 to cover the airholes 15. In one embodiment, one side of the cladding layer 40 is connected to one side of the mat body 10 having the airholes 15, and an open accommodating space 42 is formed between the cladding layer 40 and the upper surface cloth 11.

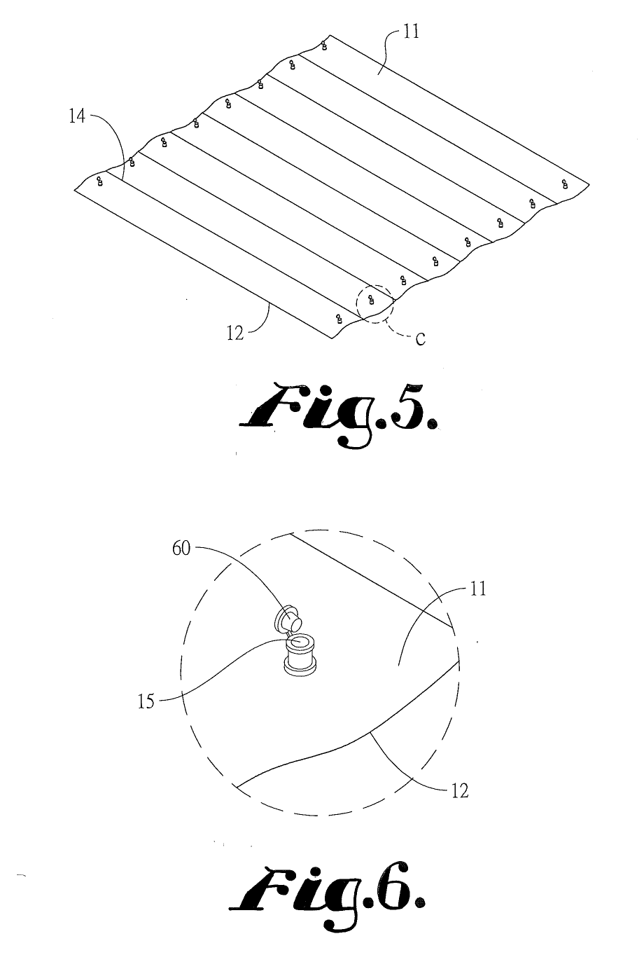

FIG. 5 shows an embodiment of the mosquito repellent and antibacterial picnic mat including a sealing portion.

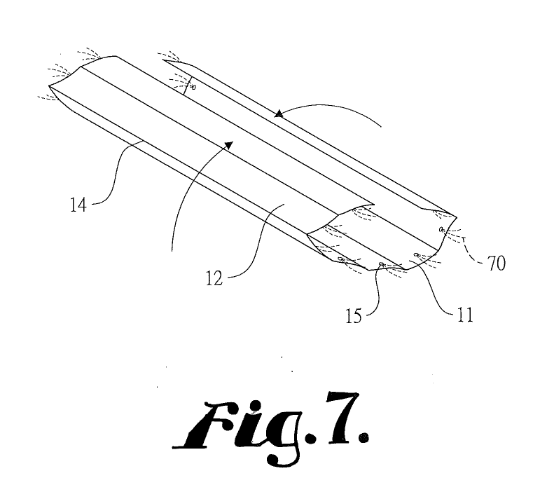

FIG. 6 shows an enlarged view associated with a sealing plug or cap 60 located in the cross section associated with the circle c in FIG. 5. The sealing caps 60 are utilized to selectively cover or plug respective airholes 15 to alternatively allow air to pass through or be blocked from passage through the airholes 15. The caps 60 block the airholes 15 to separate or isolate the filler spaces 13 from the exterior of the mat body 10. The cladding layer 40 is positioned over the airholes 15 during use to help prevent the caps 60 from opening during use and to cover the caps 60 to make sitting, or the like, on the mat 10 more comfortable for the user.

FIG. 7 shows the mosquito repellent and antibacterial picnic mat according to an embodiment of the present invention. When the mat body 10 is folded along an axial line 14 and the plurality of compressible fillers 20 having gaps are pressed, air 70 in the gaps, as seen in FIG. 7, can be released via the airholes 15, when the caps 60 are released, to reduce the volume of the mat body 10 thereby compressing the size of the mat 10 so as to allow easy portability and storage.

In conclusion, based on the disclosure of the application, the present invention achieves the expected effects and can put into commercial use. While the invention has been described by way of example and in terms of the preferred embodiments, it is to be understood that the invention is not limited thereto. On the contrary, various modifications and similar arrangements and procedures, regarded as equivalences of the concept of the invention, can be deduced based on the disclosure of teaching of the description, and the scope of the appended claims therefore should be accorded the broadest interpretation so as to encompass all such modifications and similar arrangements and procedures.

What is claimed and desired to be secured by Letters Patent is as follows:

1. A mosquito repellent and antibacterial picnic mat, comprising:
a mat body, comprising an upper surface cloth and a lower surface cloth, the upper surface cloth comprising a surface cloth layer and an adhesive coating layer, the surface cloth layer formed by a surface cloth including a mosquito repellent agent and a waterproofing agent, the adhesive coating layer provided on a surface of the surface cloth layer; the mat body further comprising a plurality of spaces with a filler arranged and located between the upper surface cloth and the lower surface cloth; and
a plurality of airholes, disposed on at least one side of the upper surface cloth of the mat body, for providing air flow communication between the plurality of filler spaces and an exterior of the mat body.

2. The mosquito repellent and antibacterial picnic mat according to claim 1, wherein the adhesive coating layer includes a coating, which comprises a polyurethane coating glue, N, N-dimethylformamide, a bridging agent and an antibacterial agent.

3. The mosquito repellent and antibacterial picnic mat according to claim 2, further comprising a plurality of compressible fillers with gaps therebetween, which respectively fill the plurality of filler spaces and the filler spaces are parallel each other.

4. The mosquito repellent and antibacterial picnic mat according to claim 2, further comprising at least one cladding layer; and one side of the at least one cladding layer is connected to at least one side of the mat body having the airholes to selectively cover the airholes.

5. The mosquito repellent and antibacterial picnic mat according to claim 4, wherein one side of the cladding layer is connected to one side of the mat body having the airholes, and an open accommodating space is formable between the cladding layer and the upper surface cloth to allow passage of air through the airholes.

6. The mosquito repellent and antibacterial picnic mat according to claim 2, further comprising a sealing portion, the sealing portion selectively covers the airholes to separate the filler spaces from the exterior of the mat body.

7. The mosquito repellent and antibacterial picnic mat according to claim 1, further comprising a plurality of compressible fillers with gaps, associated therewith the fillers respectively fill the plurality of filler spaces.

8. The mosquito repellent and antibacterial picnic mat according to claim 1, further comprising at least one cladding layer; and one side of the at least one cladding layer is connected to at least one side of the mat body having the airholes to selectively cover the airholes.

9. The mosquito repellent and antibacterial picnic mat according to claim 8, wherein one side of the cladding layer is connected to one side of the mat body having the airholes, and an open accommodating space is selectively formed between the cladding layer and the upper cloth.

10. The mosquito repellent and antibacterial picnic mat according to claim 1, further comprising a sealing portion, the sealing portion selectively covers the airholes to block air flow between the filler spaces from the exterior of the mat body.
